(19) United States
(12) Patent Application Publication
(10) Pub. No.: US 2008/0053408 A1
(43) Pub. Date: Mar. 6, 2008

(54) Fuel Injection System of Internal Combustion Engine

(75) Inventors: Yoshinori Futonagane, Shizuoka (JP); Yoshimasa Watanabe, Shizuoka (JP); Kazuhiko Seguchi, Shizuoka (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi, Aichi (JP)

(21) Appl. No.: 11/597,992

(22) PCT Filed: Mar. 27, 2006
(86) PCT No.: PCT/JP06/06991

§ 371 Date: Nov. 30, 2006

(30) Foreign Application Priority Data
Mar. 28, 2005 (JP) 2005-091584

(51) Int. Cl. F02M 69/46

(52) U.S. Cl. 123/456

(57) ABSTRACT

A fuel injection system deliberately utilizing after injection so as to improve the engine combustion and reduce soot and NOx, wherein at least one operating valve is provided for operating a first injection port group and second injection port group, after injection is performed consecutively after main injection in a high load region, fuel is injected from the first injection port group and second injection port group at the time of main injection, fuel is injected from the first injection port group at the time of after injection, the actual injection pressure near the first injection port during the after injection period is higher than the actual injection pressure near the first injection port during the main injection period, the operating valve opens the first injection port group to start the injection, then the operating valve opens the second injection port group simultaneously or in a short time as well to perform the main injection, the operating valve closes the second injection port group, then performs the after injection, and the operating valve closes the first injection port group and ends the injection after the elapse of a time longer than simultaneously or a short time from after start of after injection.

### BACKGROUND OF THE INVENTION

1. Field of the Invention

The present invention relates to a fuel injection system of an internal combustion engine (below, “engine”).

2. Description of the Related Art

In the past, there has been known a common rail type fuel injection system performing “after injection” following “main injection”. As an example of this type of fuel injection system, for example, there is the one described in Japanese Patent Publication (A) No. 2002-322957. In the fuel injection system described in Japanese Patent Publication (A) No. 2002-322957, after injection can be performed to reduce emissions. Japanese Patent Publication (A) No. 2003-254188 describes an injection rate-mode similar to after injection in FIG. 11 and Paragraph No. [0055], but does not describe the content in detail. Japanese Patent Publication (A) No. 11-182311 describes a common rail type fuel injection system performing separate after injection after main injection. Japanese Patent Publication (A) No. 2002-317727 and Japanese Patent Publication (A) No. 2002-322970 describe common rail type fuel injection systems of structures similar to the present invention.

However, in the fuel injection system described in Japanese Patent Publication (A) No. 2002-322957, the tip of the needle valve ejected the fuel for the after injection, so the actual injection pressure at the time of after injection was low. Even after performing after injection for a certain period, the soot produced at the time of the main injection could not be burned off and the NOx could not be deoxidized, so the emissions could not be sufficient reduced. Further, in this fuel injection system, the after injection period could not be freely controlled, so emissions could not be sufficiently reduced matched with the engine operating conditions. Further, in this fuel injection system, initial injection was not possible, so there were the problems of combustion noise due to the ignition lag and the inability to reduce the rapid rise of pressure in the cylinder. Further, in the fuel injection system described in Japanese Patent Publication (A) No. 11-182311, after injection could not be performed consecutively after main injection or the actual injection pressure at the time of after injection was insufficient, so emissions could not be sufficiently reduced. Further, in this fuel injection system, there was the problem that main injection could not be performed consecutively after the initial injection.

The initial injection, main injection, and after injection will be explained in detail below. FIG. 8B shows the amount of fuel injection per time of the fuel injection system according to the present invention, that is, the injection rate. As shown in FIG. 8B, the period from the time t₂ to t₅ is expressed as “T₁” and referred to as the “initial injection period”, the period from the time t₅ to t₉ is expressed as “T₂” and referred to as the “main injection period”, and the period from the time t₉ to t₁₂ is expressed as T₃ and referred to as the after injection period. The initial injection is also called “pilot injection” and reduces the combustion noise due to an ignition lag in diesel combustion or the NOx. Main injection is mainly for obtaining a high output. On the other hand, the evaluation of after injection has changed as explained above.

Here, the effect of after injection on engine cylinder combustion will be explained. The main factor determining the limit of output in a diesel engine is the soot. By reducing the soot, the limit of output can be raised and a higher output can be obtained. After injection is not deliberately aimed at in a conventional fuel injection system, but is a phenomenon which occurs due to various factors. It causes the so-called “afterburn” phenomenon where the actual injection pressure is low and becomes a factor of production of soot. Further, if adding after injection, the total injection period increases, so there was also cause for concern that the combustion period would increase and the cylinder cycle efficiency would deteriorate. Therefore, technical development has been heading in the direction of eliminating the after injection period as much as possible. However, in recent years, as shown in Japanese Patent Publication (A) No. 2002-322957 and Japanese Patent Publication (A) No. 11-182311, inventions taking note of after injection have also been developed. Still, there has been insufficient use of after injection for engine cylinder combustion.

### SUMMARY OF THE INVENTION

An object of the present invention is to provide a fuel injection system which deliberately uses after injection to improve engine combustion and reduce soot and NOx. Further, it has as its object to provide a fuel injection system enabling also initial injection for reducing the noise due to ignition lag or NOx.

In view of this situation, the inventors searched for ways to deliberately utilize after injection for engine combustion and repeatedly conducted experiments and simulations. As a result, they discovered that by deliberately using after injection under certain conditions, it is possible to remarkably improve the engine combustion performance, reduce the soot and NOx, and greatly enhance the output.

The new concept of this after injection is as follows:

(1) A common rail type fuel injection system enabling high pressure injection regardless of the engine speed is employed and two types of injection port groups are provided.

(2) Under a high load, it is necessary to inject the main amount of fuel into the cylinder in a short time, so large sectional area injection ports are used to inject the main amount of fuel into the cylinder (main injection). The reason for injecting fuel in a short time is to generate heat in a short time and improve the engine cycle efficiency. This atomized fuel has a large penetration (that is, kinetic energy of particles of fuel) due to the use of the large sectional area injection ports and the fuel is hard to be increased in fineness. Therefore, combustion by this atomized fuel produces soot.

(3) Right after the main injection, the after injection is consecutively performed for a certain period (period far exceeding period considered in the past, for example, period of same extent as main injection). Due to this, the after injection period inevitably becomes longer than the initial injection period. In this case, making the actual injection pressure at the time of after injection larger than the actual injection pressure at the time of main injection is an essential condition. (Due to this, the atomized fuel due to after injection becomes a state close to a gas.) This, for example, is achieved by performing the main injection mainly from an injection port group with a large total injection port area (injection in combination from injection port group with small total injection port area also possible) and performing after injection from the injection port group with a small total injection port area. Further, the amount of after injection is preferably smaller than the amount of main injection. By suppressing the amount of generation of heat by the amount of after injection, deterioration of the engine cycle efficiency can be suppressed.

(4) In the after injection, small sectional area injection ports are used, so the fuel becomes finer. Further, the penetration is small (that is, the kinetic energy of the particles of fuel is small), so the atomized fuel never collides with the wall surfaces of the piston cavity combustion chamber. (If the atomized fuel collides with the wall surfaces of the combustion chamber, it becomes difficult to form an air-fuel mixture entrapping the air around the atomized fuel, combustion deteriorates, and soot is easily produced.) On top of this, the atomized fuel due to the after injection burns while pushing the incompletely burning atomized fuel due to the immediately preceding main injection (close to gas combustion) from behind, so the incomplete combustion of atomized fuel due to the main injection changes to complete combustion. Further, to enable the soot derived from the combustion of the main injection to be completely burned off, after injection is performed for a certain long period (for example, period of same extent as main injection) to cause combustion close to gas combustion. At this time, along with this, the atomized fuel due to the after injection deoxidizes the NOx due to the combustion of the main injection, so the NOx can also be greatly reduced. The atomized fuel due to the after injection is in a state close to a gas, so the NOx deoxidization action is efficiently manifested.

(5) As explained in further detail, by making the actual injection pressure at the time of after injection larger than the actual injection pressure at the time of main injection, immediately before the after injection, particles of fuel made much finer than the particles remaining and burning in the piston cavity combustion chamber (due to main injection) can be atomized from behind the particles of fuel being burned so as to promote the combustion. That is, the soot being produced during combustion of the atomized fuel due to the main injection can be almost completely burned off immediately after the production of the soot by the combustion of the atomized fuel (close to gas combustion) containing particles of fuel (close to gas) made much finer by the after injection, with small kinetic energy, and proceeding slowly from behind the soot (due to small kinetic energy of particles of fuel).

The results of simulation of atomized fuel according to this concept are shown in FIG. 1. The simulation of atomized fuel of FIG. 1 is based on the injection mode of FIG. 2. Further, FIG. 2 shows the injection rate with respect to the engine crank angle in the fuel injection system according to this concept. The fuel injection starts at 10 degree crank angle before compression top dead center (TDC) and ends at 15 degree crank angle after TDC.

FIGS. 1A to 1D, for simplification, shows a sectional view of the left half of a piston cavity combustion chamber from the cylinder center. In actuality, at the right half as well, the same atomized fuel is symmetrically formed about the cylinder center. n indicates an injection nozzle, p a piston, h a cylinder head, c a piston cavity combustion chamber, s atomized fuel injected from the injection nozzle n, and x a cylinder centerline.

FIG. 1A shows atomized fuel due to main injection 5 degrees before TDC, FIG. 1B shows atomized fuel due to main injection at TDC, FIG. 1C shows atomized fuel 5 degrees after TDC, and FIG. 1D shows atomized fuel due to after injection 10 degrees after TDC. The black part in the atomized fuel is a part of high fuel concentration and is also a location where soot is easily produced at the time of combustion.

As shown in FIGS. 1A to 1C, the part of high fuel concentration (black part) at the time of main injection strikes the piston cavity shoulder p1 and travels along the inside wall of the piston cavity combustion chamber c to accumulate at the bottom c1 of the piston cavity combustion chamber. Further, in FIG. 1D, the atomized fuel sa due to the after injection is burned while pushing the high fuel concentration air-fuel mixture produced due to the immediately preceding main injection (accumulating at the bottom c1 of the piston cavity combustion chamber) from behind. This state is shown well.

On the other hand, FIG. 3 shows the results of calculation of the amount of production of soot in three cases of fixing the amount of injection per time at 55.5 mm³/st corresponding to full load and making the main injection period T₂ and after injection period T₃ variable in a fuel injection system according to the present invention for a four-cylinder, 82.2 mm cylinder diameter, 94 mm stroke four-cycle diesel engine (hereinafter referred to as an “X engine”). The amount of production of soot is per cycle of the engine.

As shown in case A of FIG. 3, by increasing the after injection period T₃ to close to the main injection period T₂, the amount of production of soot per cycle can reduced to 6 μg. The amount of production of soot can therefore be greatly reduced compared with the case C of no after injection (27 μg).

The inventors are busy collecting data in the test system (X engine) of the present invention as well. The case A is greatly increased over the case C in high speed torque (limited by soot limit). That is, the case A is not that much lower in allowable torque even at an engine speed of 5000 rpm, but in the case C, soot is produced at 4000 rpm or more—making it difficult to apply a torque (load). Further, the maximum output of case A is, at the present stage, increased about 12% compared with the case C. In this way, the X engine employing the case A exhibits good performance as an automobile engine.

As explained above, the means for solving this problem is a fuel injection system able to perform after injection able to form atomized fuel increased in fineness of the fuel particles and with a smaller penetration (smaller kinetic energy) than the main injection for a certain period (period greatly exceeding conventionally considered period) so as to obtain the merit of the effect of reduction of emissions, able to variably control the after injection period, and enabling initial injection as well. Specifically, this new concept can be embodied in the following devices.

According to a first aspect of the invention, there is provided a fuel injection system storing pressure of the high pressure fuel fed from a fuel feed pump in a common rail and injecting the high pressure fuel stored in the common rail into a combustion chamber of an internal combustion engine, the fuel injection system characterized by being provided with a valve body, a first injection port group and second injection port group provided at the valve body and injecting fuel, and at least one operating valve opening/closing the first injection port group and the second injection port group; performing after injection consecutively after main injection in a high load region, injecting fuel from the first injection port group and the second injection port group at the time of main injection, and injecting fuel from the first injection port group at the time of after injection; controlling an actual injection pressure near the first injection port during the after injection period to be higher than an actual injection pressure near the first injection port during the main injection period; and controlling the operating valve to open the first injection port group to start injection, then controlling the operating valve to open the second injection port group as well to perform main injection simultaneously or in a short time, then controlling the operating valve to close the second injection port group then perform after injection, and, after the elapse of a time longer than the simultaneously or short time from the start of injection, controlling the operating valve to also close the first injection port group to end injection.

According to the first aspect of the invention, there is provided a fuel injection system increasing the actual injection pressure at the time of after injection and performing after injection for a certain period. The “certain period” is a time longer than the initial injection period and is a period much longer than the conventionally considered period. Since the actual injection pressure is high, the particles of fuel become finer, and the atomized fuel due to the after injection burns while pushing the incompletely burning atomized fuel due to the immediately preceding main injection from behind (close to gas combustion), so the incomplete combustion of atomized fuel due to the main injection changes to complete combustion. Further, the soot due to the combustion of the main injection can be burned off by performing the after injection for a certain long period to cause combustion close to gas combustion.

At this time, along with this, the atomized fuel due to the after injection deoxidizes the NOx due to the combustion of the main injection, so the NOx can also be greatly reduced. The atomized fuel due to the after injection is in a state close to a gas, so the NOx deoxidization action is efficiently obtained. Explaining this in more detail, by making the actual injection pressure at the time of after injection larger than the actual injection pressure at the time of main injection, it is possible to inject particles of fuel increased in fineness from the particles of fuel remaining in the piston cavity combustion chamber immediately before the after injection (due to main injection) and in the process of burning from behind into the particles of fuel being burned so as to promote the combustion.

That is, by the combustion of the atomized fuel having particles of fuel increased in fineness (close to gas) by the after injection and small in kinetic energy and proceeding slowly from behind the soot (due to small kinetic energy of particles of fuel) (close to gas combustion), it is possible to substantially completely burn off the soot produced during combustion of the atomized fuel due to the main injection immediately after production of the soot. By greatly reducing the soot, the output limit which had been restricted by the soot can be greatly raised, the output can be improved, and the high speed torque performance is also greatly improved. In this way, by after injection for a certain long period of time by a high actual injection pressure, it is possible to obtain the merits of the effect of reduction of emissions.

According to a second aspect of the invention, there is provided a fuel injection system as set forth in the first aspect of the invention characterized by enabling the injection period of the after injection to be variably controlled. According to the second aspect of the invention, since the after injection period can be variably controlled, it is possible to match the injection mode with the engine operating conditions and thereby reduce emissions.

According to a third aspect of the invention, there is provided a fuel injection system as set forth in the first aspect of the invention or the second aspect of the invention wherein the speed by which the operating valve moves from a full lift position to a closing position when closing the first injection port group by the operating valve is slower than the speed by which the operating valve moves from the closing position to the full lift position when opening the first injection port group by the operating valve. According to the third aspect of the invention, by a simple, single, specific technique, it is possible to perform after injection for a certain period (period much longer than conventionally considered period) and obtain the merit of the effect of reduction of emissions due to the high actual injection pressure.

According to a fourth aspect of the invention, there is provided a fuel injection system as set forth in any one of the first aspect of the invention to the third aspect of the invention wherein a total injection port area of the first injection port group is not more than a total injection port area of the second injection port group and the injection port sizes of the first injection ports are not more than the injection port sizes of the second injection ports. According to the fourth aspect of the invention, since the total injection port area of the first injection port group is not more than the total injection port area of the second injection port group, it is possible to more reliably more greatly increase the actual injection pressure at the time of the after injection. Further, when the injection port sizes of the first injection ports are not more than the injection port sizes of the second injection ports, the particles of fuel in the atomized fuel due to the after injection are made finer, afterburn close to a gas can be achieved, and emissions can be greatly reduced. Further, by performing the main injection from the injection port group with the large total injection port area (injection in combination from the injection port group with the small total injection port area also possible) and performing the after injection from the injection port group with the small total injection port area, it is possible to increase the after injection period and reduce the amount of after injection from the amount of main injection. By suppressing the amount of generation of heat due to the amount of after injection, it is possible to also achieve a great reduction in the emission and suppress deterioration of the engine cycle efficiency.

According to a fifth aspect of the invention, there is provided a fuel injection system as set forth in any one of the first aspect of the invention to the fourth aspect of the invention wherein the first injection port group is arranged at an upstream side constituting a fuel feed side, while the second injection port group is arranged at a downstream side at an opposite side to the fuel feed side. According to the fifth aspect of the invention, by arranging the first injection ports for the after injection at the fuel feed side enabling a higher pressure closer to the common rail pressure to be secured, it is possible to make the actual injection pressure at the time of after injection higher more reliably and possible to obtain the merit of the effect of reduction of emissions even more.

According to a sixth aspect of the invention, there is provided a fuel injection system as set forth in any one of the first aspect of the invention to the fifth aspect of the invention wherein fuel is injected consecutively in the order of initial injection, main injection, and after injection, fuel is injected from the first injection port group at the time of the initial injection, fuel is injected from the first injection port group and the second injection port group at the time of main injection, and fuel is injected from the first injection port group at the time of after injection. According to the sixth aspect of the invention, since the initial injection is added, the rapid rise in cylinder pressure and combustion noise due to ignition lag can be reduced and emissions (in particular NOx) can be reduced more.

According to a seventh aspect of the invention, there is provided a fuel injection system as set forth in any one of the first aspect of the invention to the sixth aspect of the invention wherein fuel is injected from only the first injection port group in a partial load region and fuel is injected from both the first injection port group and the second injection port group in a high load region.

According to the seventh aspect of the invention, the amount of fuel injected can be kept small in the partial load region. By not injecting fuel from the second injection port group where soot is liable to be produced and injecting fuel only from the first injection port group, it is possible to reduce emissions. On the other hand, in the high load region where a high output and torque are required, by injecting a large amount of fuel from the first injection port group and second injection port group in the initial period of injection; the cycle efficiency can be kept from deteriorating. On the other hand, the soot produced by combustion of this large amount of injected fuel can be substantially completely later burned off by combustion of the atomized fuel made finer at the time of after injection.

According to an eighth aspect of the invention, there is provided a fuel injection system as set forth in is any one of the first aspect of the invention to the seventh aspect of the invention wherein the valve body is formed in a closed-bottom cylindrical shape, is fed with fuel in the cylinder, and has the first injection port group and the second injection port group at its bottom side; and the operating valve is housed in the valve body to be able to freely move back and forth and is provided with at least one control chamber communicated with the common rail and controlling the operation of the operating valve, at least one control valve chamber communicated with the control chamber, and at least one control valve for controlling the fuel pressure in the control valve chamber.

According to the eighth aspect of the invention, by this specific constitution, it becomes possible to increase the actual injection pressure at the time of after injection, perform the after injection for a certain period, and obtain the merit of the effect of reduction of emissions by the high actual injection pressure. Further, it is possible to adopt a configuration enabling control of two operating valves independently and to variably control the after injection period to match with the engine operating conditions and reduce emissions.

According to a ninth aspect of the invention, there is provided a fuel injection system as set forth in the eighth aspect of the invention wherein a passage communicating the common rail and the control chamber is provided with an inlet orifice, a passage communicating the control chamber and the control valve chamber is provided with an outlet orifice, and a passage sectional area of the inlet orifice is smaller than a passage sectional area of the outlet orifice. According to the ninth aspect of the invention, the speed of rise of the operating valve becomes greater, but the speed of descent of the operating valve becomes smaller, so a simple, specific mechanism enabling working of the third aspect of the invention is provided.

According to a 10th aspect of the invention, there is provided a fuel injection system as set forth in the eighth aspect of the invention or the ninth aspect of the invention wherein the at least one operating valve is comprised of a first operating valve opening/closing the first injection port group and a second operating valve opening/closing the second injection port group, the first operating valve and the second operating valve are comprised of outside tube members and members inserted into the outside tube members, the control chamber is comprised of a first control chamber for controlling the operation of the first operating valve and a second control chamber for controlling the operation of the second operating valve, and the control valve chamber is communicated with the first control chamber and the second control chamber. According to the 10th aspect of the invention, production is easy and concentric needle valves superior in seatability at the seat part near the second injection ports can be used.

According to an 11th aspect of the invention, there is provided a fuel injection system as set forth in the 10th aspect of the invention wherein a lift lock piston is disposed between the first control chamber and the second control chamber. According to the aspect of the invention as set forth in the 11th aspect of the invention, by arranging a lift lock piston between the first control chamber and the second control chamber, the lift of the operating valve when the first injection port is completely opened and the lift of the operating valve when the first injection port and second injection port are completely opened are accurately set.

According to a 12th aspect of the invention, there is provided a fuel injection system as set forth in the 10th aspect of the invention or the 11th aspect of the invention, wherein a passage communicating the common rail and the first control chamber is provided with a first inlet orifice, a passage communicating the common rail and the second control chamber is provided with a second inlet orifice, a passage communicating the first control chamber and the control valve chamber is provided with a first outlet orifice, a passage communicating the second control chamber and the control valve chamber is provided with a second outlet orifice, and a passage cross-sectional area of the second outlet orifice is larger than a passage sectional area of the first inlet orifice. According to the 12th aspect of the invention, the speed of rise of the operating valve becomes greater, but the speed of descent of the operating valve becomes smaller, so a simple, specific mechanism enabling working of the third aspect of the invention is provided. Further, at the time of start of the initial injection, the first injection port opens, then the second injection port opens, while at the time of start of after injection, the second injection port closes, then the first injection port closes.

According to a 13th aspect of the invention, there is provided a fuel injection system as set forth in any one of the eighth aspect of the invention to the 12th aspect of the invention, wherein the control valve is a three-position control valve. According to the 13th aspect of the invention, by using a three-position control valve, the after injection period can be controlled more freely than a two-position control valve. That is, the freedom of control is greatly improved.

### BRIEF DESCRIPTION OF THE DRAWINGS

These and other objects and features of the present invention will become clearer from the following description of the preferred embodiments given with reference to the attached drawings, wherein:

FIGS. 1A to 1D show a simulation of atomized fuel based on the invention of the present application;

FIG. 2 shows an injection mode based on the atomized fuel simulation of FIG. 1;

FIG. 3 shows the amount of production of soot when changing the after injection period;

FIG. 4 is a sectional view at the time of noninjection in the injection system according to the first embodiment;

FIG. 5 is a sectional view at the time of main injection in the injection system according to the first embodiment;

FIG. 6 is a sectional view at the time of after injection in the injection system according to the first embodiment;

FIG. 7 is an enlarged view of the tip of the needle valve of FIG. 4;

FIGS. 8A to 8E are views of the operation of the first embodiment;

FIG. 9 is a sectional view at the time of noninjection in the injection system according to a second embodiment;

FIG. 10 is a sectional view at the time of noninjection in the injection system according to a third embodiment;

FIG. 11 is a sectional view at the time of main injection in the injection system according to the third embodiment;

FIG. 12 is a sectional view at the time of after injection in the injection system according to the third embodiment;

FIGS. 13A to 13E are views of the operation of the third embodiment;

FIG. 14 is a sectional view at the time of noninjection in the injection system according to a fourth embodiment;

FIG. 15 is a sectional view at the time of noninjection in the injection system according to a fifth embodiment;

FIG. 16 is a sectional view at the time of noninjection in the injection system according to a sixth embodiment;

FIG. 17 is a sectional view at the time of main injection in the injection system according to the sixth embodiment;

FIG. 18 is a sectional view at the time of after injection in the injection system according to the sixth embodiment;

FIG. 19 is an enlarged view of the tip of the needle valve of FIG. 16;

FIGS. 20A to 20D are views of the operation of the sixth embodiment;

FIG. 21 is a sectional view at the time of noninjection in the injection system according to a seventh embodiment;

FIG. 22 is a sectional view at the time of main injection in the injection system according to the seventh embodiment;

FIG. 23 is a sectional view at the time of after injection in the injection system according to the seventh embodiment;

FIGS. 24A to 24D are views of the operation of the seventh embodiment; and

FIG. 25 is a sectional view at the time of noninjection in the injection system according to an eighth embodiment.

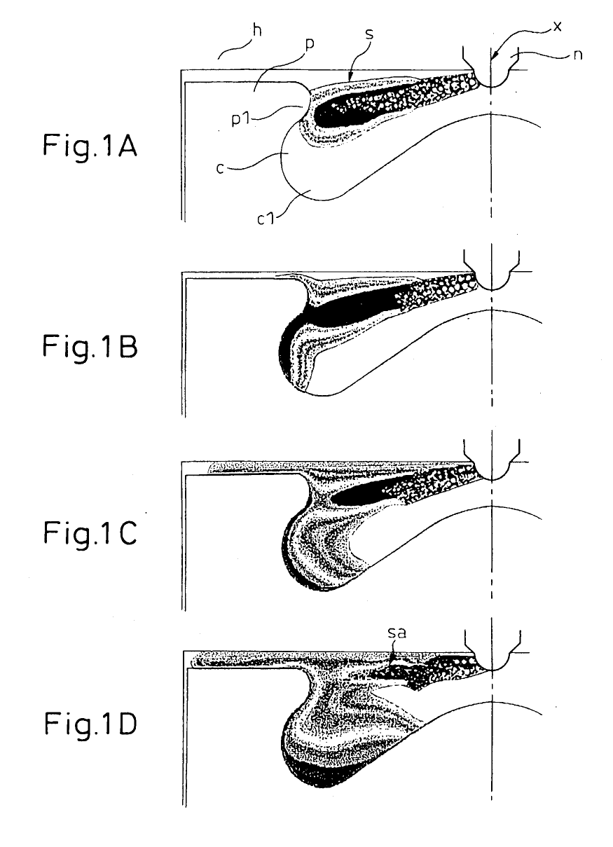

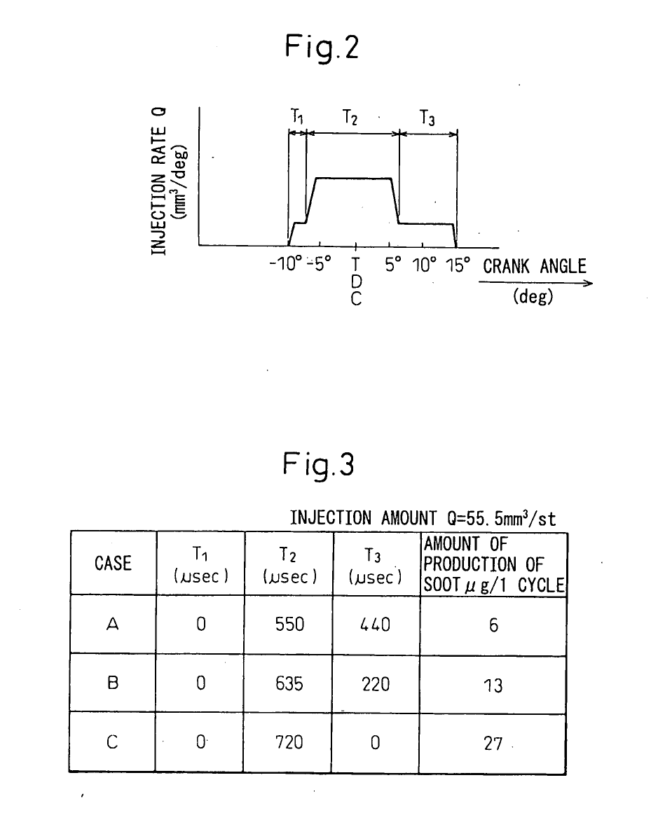

### BEST MODE FOR WORKING THE INVENTION

Below, embodiments of the fuel injection system according to the present invention will be explained using the attached drawings. The following embodiments are specific examples of devices required for utilizing this new concept. Note that in all of the drawings, parts having the same functions are assigned the same reference numerals.

### First Embodiment

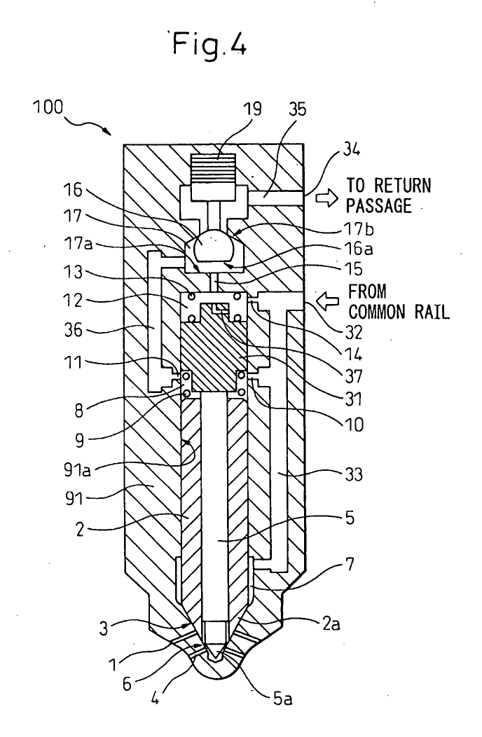

FIG. 4 is a cross-sectional view of a first embodiment of the fuel injection system according to the present invention. At the time of noninjection when fuel is not injected as shown in FIG. 4, the amounts of lift of the injection port operating valves constituted by the first needle valve and the second needle valve become zero. In FIG. 4, 1 indicates first injection ports from which fuel is injected at the time of initial injection, main injection, and after injection, 2 indicates the first needle valve for opening/closing the first injection ports 1, and 3 is a first seat part where the first needle valve 2 is seated at the time the first needle valve 2 closes the ports. Reference numeral 4 indicates second injection ports from which fuel is injected at the time of main injection, 5 indicates a second needle valve arranged at the inside of the first needle valve 2 for opening/closing the second injection ports 4, 6 indicates a second seat part where the second needle valve 5 is seated when the second needle valve 5 closes the ports, and 91 indicates a valve body. In the first embodiment, the first needle valve 2 and the second needle valve 5 are arranged so as to lift at the top side. Note that the first needle valve 2 is arranged slidably in the cylinder part 91a of the valve body 91. Note that the concentric needle valves of this embodiment are simpler in structure compared with the later mentioned integral type needle valve and is superior in seatability at the second seat part.

Pluralities of the first injection ports 1 and second injection ports 4 are arranged to form a first injection port group and second injection port group. The total injection port area of the first injection port group is made not more than the total injection port area of the second injection port group, while the injection port sizes of the first injection ports are made not more than the injection port sizes of the second injection ports. The total injection port area of the first injection port group is set to not more than the total injection port area of the second injection port group to make the injection rate Q₁ of the after injection smaller than the injection rate Q₂ of the main injection and suppress deterioration of the engine cycle efficiency. By making the injection port sizes of the first injection ports not more than the injection port sizes of the second injection ports, the particles of the atomized fuel of the after injection become finer and smaller in kinetic energy and gaseous combustion with little progression of atomized fuel is formed, the soot produced by the main injection can be burned off, and the NOx can be efficiently deoxidized.

Reference numeral 7 indicates a fuel feed passage for feeding fuel to the first injection ports 1 and second injection ports 4. The fuel in the fuel reservoir chamber 7 causes the first needle valve 2 to be biased to the opening side (top side of FIG. 4). Further, the second needle valve 5 is biased by the fuel to the opening side (top side of FIG. 4) after the first needle valve 2 opens. Note that, as shown in Japanese Patent Publication (A) No. 2002-322970, a communication port is opened in the first needle valve 2, the fuel is fed to the tip of the second needle valve 5, and therefore the first needle valve 2 and the second needle valve 5 can be biased to the opening side (top side of FIG. 4) (Japanese Patent Publication (A) No. 2002-322970, Paragraph No. [0019]).

Reference numeral 8 indicates a first control chamber for biasing the first needle valve 2 to the closing side (bottom side of FIG. 4), 9 indicates a first spring for biasing the first needle valve 2 to the closing side (bottom side of FIG. 4), 10 indicates a first inlet orifice for setting the amount of fuel flowing into the first control chamber 8, and 11 is a first outlet orifice for setting the amount of fuel flowing out from the first control chamber 8. Reference numeral 12 indicates a second control chamber for biasing the second needle valve 5 to the closing side (bottom side of FIG. 4) through the lift lock piston 31, 13 indicates a second spring for biasing the second needle valve 5 to the closing side (bottom side of FIG. 4) through the lift lock piston 31, 14 indicates a second inlet orifice for setting the amount of fuel flowing into the second control chamber 12, and 15 indicates a second outlet orifice for setting the amount of fuel flowing out from the second control chamber 12. Reference numeral 31 is a lift lock piston which is set slidably in the cylinder part 91a of the valve body 91. The lift lock piston 31 defines the maximum amounts of lifts of the first needle valve 2 and the second needle valve 5 and is for securing the sectional area of the route of the fed fuel to the first injection port 1 and second injection port 4 or for preventing the first spring and second spring from breaking due to metal fatigue.

Reference numeral 16 indicates a pressure control valve for controlling the pressure in the first control chamber 8 and the pressure in the second control chamber 12. In the first embodiment, the pressure control valve 16 is a three-position control valve and is arranged so as to lift at the bottom side. Reference numeral 17 is a control valve chamber housing the pressure control valve 16. Reference numeral 19 is a piezo type actuator for driving the pressure control valve 16. In the first embodiment, a piezo type actuator is used for driving the pressure control valve 16, but any other actuator can also be used. The second needle valve 5 is guided by a guide member constituted by the first needle valve 2 and can slide to the opening side (top side of FIG. 4) and the closing side (bottom side of FIG. 4). Reference numeral 37 indicates a communication port for communicating the control valve chamber 17 and the second control chamber 12 so as not to block the second outlet orifice 15 even when the second control chamber 12 drops in fuel pressure, the lift lock piston 31 rises, and the top end face of the piston 31 abuts at the ceiling surface of the second control chamber 12 near the second outlet orifice 15.

At the time of noninjection where the first injection port 1 and second injection port 4 shown in FIG. 4 do not inject fuel, the amount of lift of the pressure control valve 16 is made zero. For this reason, the fuel in the control valve chamber 17 can no longer flow out to the return passage, and the control valve chamber 17, first control chamber 8, and second control chamber 12 rise in pressure. As a result, the first needle valve 2 and the second needle valve 5 are biased to the closing side (bottom side of FIG. 4), and the amounts of lift of the first needle valve 2 and the second needle valve 5 become zero.

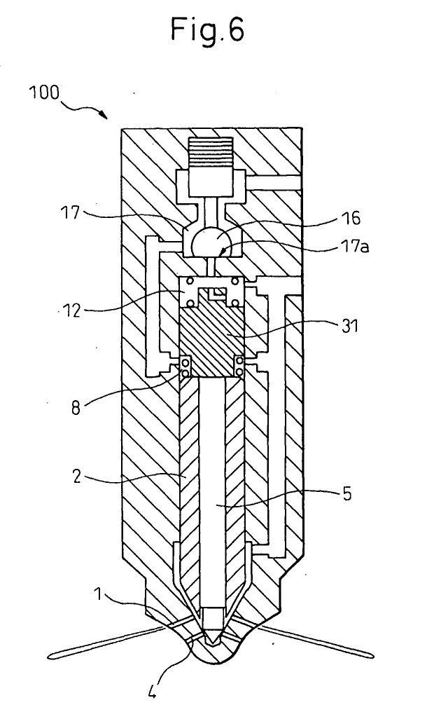

FIG. 6 is a view similar to FIG. 4 showing the time of after injection where the second injection ports do not inject fuel, but the first injection ports inject fuel (or at the time of initial injection). As shown in FIG. 6, at the time of after injection where the second injection ports 4 do not inject fuel, but the first injection ports 1 inject fuel (or at the time of the initial injection), the pressure control valve 16 is arranged at the full lift position. For this reason, since the second outlet orifice 15 becomes closed, the fuel in the second control chamber 12 cannot flow out to the control valve chamber 17 and naturally also cannot flow out to the return passage, so the second control chamber 12 is maintained in the high pressure state. As a result, the amount of lift of the second needle valve 5 through the lift lock piston 31 is held as it is as zero and fuel is not injected from the second injection ports 4.

On the other hand, the fuel in the first control chamber 8 cannot flow through the first outlet orifice 11 and control valve chamber 17 to the return passage, so the first control chamber 8 falls in pressure. As a result, the force F₁ generated due to the fuel pressure at the bottom tip 2a of the first needle valve 2 and acting on the first needle valve 2 in the upward direction overcomes the force F₁ generated due to the pressure in the first control chamber 8 and acting on the first needle valve 2 in the downward direction, the first needle valve 2 is lifted, and the first injection ports 1 inject fuel.

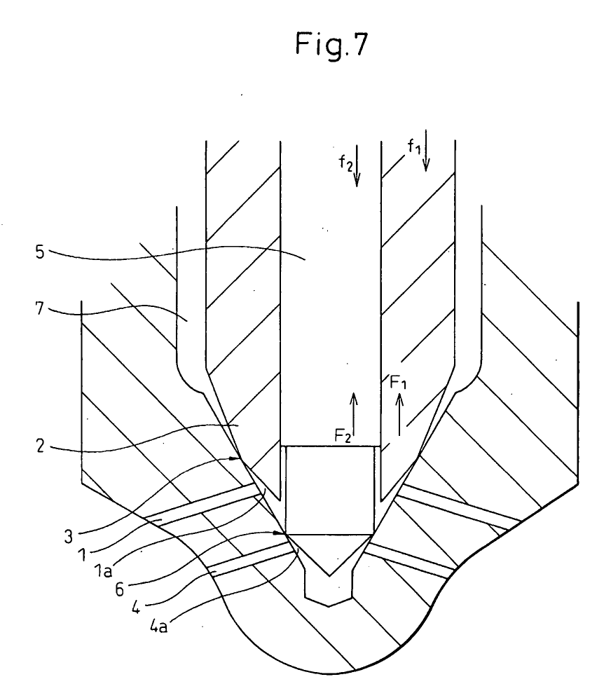

Note that the force f₁ received by the needle valve from the fuel of the control chamber in the direction seating on the seat part is proportional to the pressure receiving area of the needle valve receiving the fuel pressure from the control chamber. The force received by the needle valve from the fuel pressure around the needle valve in the direction separating from the seat part is proportional to the (sectional area of the needle valve—seat area of the needle valve). In addition to the fuel pressure, the needle valve receives a biasing force from a coil spring or other spring member in the direction seating on the seat part (see FIG. 7).

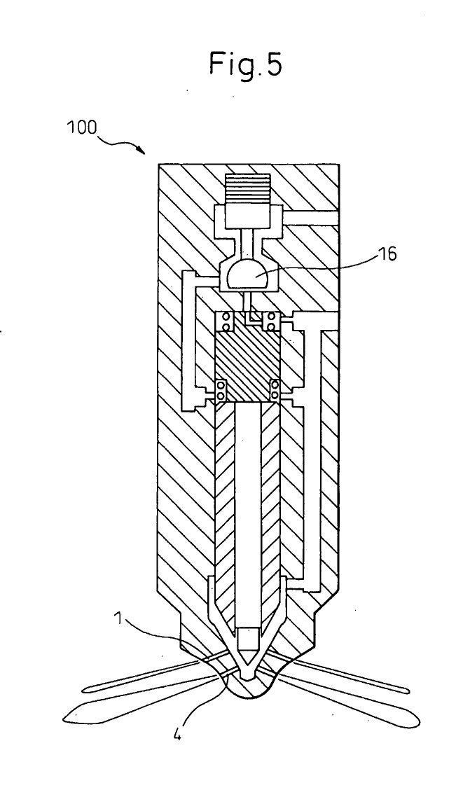

FIG. 5 is a view showing the time of main injection where fuel is injected from both the first injection ports and second injection ports and is similar to FIG. 4. As shown in FIG. 5, at the time of main injection where fuel is injected from both the first injection ports 1 and second injection ports 4, the pressure control valve 16 is arranged at the intermediate lift position. For this reason, in the same way as the case shown in FIG. 6, the fuel in the first control chamber 8 also flows out through the first outlet orifice 11 and control valve chamber 17 to the return passage, and the first control chamber 8 falls in pressure. As a result, in the same way as the case shown in FIG. 6, the first needle valve 2 is lifted and fuel is injected from the first injection ports 1. Further, the fuel in the second control chamber 12 can flow out through the second outlet orifice 15 and control valve chamber 17 to the return passage, so the second control chamber 12 falls in pressure. As a result, the force F₂ generated due to the fuel pressure at the bottom tip 5a of the second needle valve 5 and acting on the second needle valve 5 in the upward direction overcomes the force f₂ generated due to the pressure in the second control chamber 12 and acting on the second needle valve 5 in the downward direction, the second needle valve 5 is lifted, and the second injection ports 4 injects fuel.

FIG. 7 is an enlarged view of FIG. 5 showing details of the route of the fuel from the fuel reservoir chamber 7 to the first injection ports 1 and second injection ports 4. As shown in FIG. 7, the fuel to be injected from the first injection ports 1 travels from the fuel reservoir chamber 7 through the first seat part 3 to be supplied to the first injection ports 1 and then is injected from the first injection ports 1. Further, the fuel to be injected from the second injection ports 4 travels from the fuel reservoir chamber 7 through the first seat part 3 and through the second seat part 6 to be supplied to the second injection ports 4 and then is injected from the second injection ports 4. That is, the fuel to be injected from the second injection ports 4 first passes through the first seat part 3, then passes through the second seat part 6 and is supplied to the second injection ports 4. F₁ is the force acting on the first needle valve 2 in the upward direction, f₁ is the force acting on the first needle valve 2 in the downward direction, F₂ is the force acting on the second needle valve 5 in the upward direction, and f₂ is the force acting on the second needle valve 5 in the downward direction.

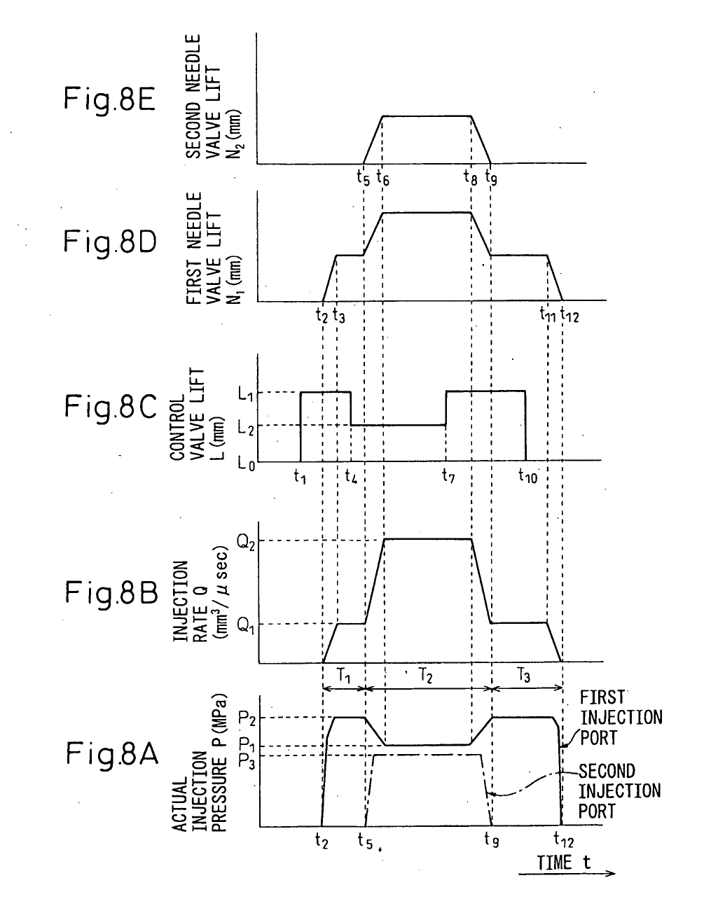

Here, the operation of the fuel injection system 100 according to the first embodiment will be explained with reference to FIG. 8. Note that FIG. 8A shows the actual injection pressure of the first injection ports with respect to the time t in the fuel injection system 100 as constituted by the calculated fuel pressure near the first injection port, FIG. 8B shows the amount of injection with respect to time in the system, that is, the injection rate, FIG. 8C shows the lift of the control valve with respect to time in the system, FIG. 8D shows the lift of the first needle valve with respect to time in the system, and FIG. 8E shows the lift of the second needle valve with respect to time in the system. In FIGS. 8A to 8E, the time axes are exactly the same.

(1) The control system inputs a drive pulse to the piezo type actuator drive circuit. At the time t₁, when the drive circuit applies a maximum voltage to the piezo type actuator 19, as shown in FIG. 8C, the control valve 16 coupled with the piezo type actuator moves from the closing position L₀ to the bottom side of FIG. 4, abuts against the bottom surface 17a of the control valve chamber 17, and is maintained at that abutting position as it is. The abutting position becomes the full lift position L₁ of the control valve 16. Due to this, the fuel in the first control chamber 8 can pass through the first outlet orifice 11 and control valve chamber 17 and flow out to the return passage, so the first control chamber 8 falls in pressure. As a result, the force. F₁ generated due to the fuel pressure at the bottom tip 2a of the first needle valve 2 and acting on the first needle valve 2 in the upward direction overcomes the force f₁ generated due to the pressure in the first control chamber 8 and acting on the first needle valve 2 in the downward direction. As shown in FIG. 8D, at the time time t₂, the first needle valve 2 starts to be lifted to the top side of FIG. 4, the seat part 3 is opened, the first injection ports 1 start to inject fuel, and the initial injection starts. Further, at the time t₃, the first needle valve 2 is intermediately lifted and is maintained as it is. At this time, as shown in FIG. 8B, the amount of injection per time from the first injection ports 1, that is, the injection rate, becomes Q₁. On the other hand, since second outlet orifice 15 is closed, the second control chamber 12 is maintained in the high pressure state as it is, the second needle valve 5 is not lifted via the lift lock piston 31 but is maintained as it is, and the second injection ports 4 inject fuel.

(2) Further, at the time t₄, when the maximum voltage applied to the piezo type actuator 19 is reduced to the intermediate voltage, as shown in FIG. 8C, the control valve 16 moves from the full lift position L₁ to the top side of FIG. 4 and is maintained as is in the intermediate lift position L₂ not abutting against either the bottom surface 17a or seat surface 17b of the control valve chamber 17. As a result, further, the fuel in the second control chamber 12 can pass through the second outlet orifice 15 and control valve chamber 17 and flow out to the return passage, so the second control chamber 12 falls in pressure. As shown in FIG. 8E, at the time t₅, the second needle valve 5 starts to be lifted, the second injection ports 4 start to inject fuel as well, and main injection is started. At this time, the first needle valve 2 also moves to the top side following the ascent of the second needle valve 5. Further, at the time t₆, the second needle valve 5 and the first needle valve 2 are fully lifted and maintained as they are. At this time, as shown in FIG. 8B, the amount of injection per time from the first injection ports 1 and second injection ports 4, that is, the injection rate, becomes the maximum value Q₂.

(3) Further, at the time t₇, when the intermediate voltage applied to the piezo type actuator 19 is again increased to the maximum voltage, as shown in FIG. 8C, the control valve 16 moves from the intermediate lift position L₂ to the bottom side of FIG. 4 and is maintained as it is as the full lift position L₁. As a result, the control valve 16 closes the second outlet orifice 15, so the second control chamber 12 rises in pressure due to the supply of fuel from the common rail and finally reaches the common rail pressure, so at the time t₈, the second needle valve 5 starts to move to the bottom side of FIG. 4 via the lift lock piston 31 (simultaneously, the first needle valve 2 is also pushed by the piston 31 and moves to the bottom side). At the time t₈, the second injection ports 4 are closed and maintained as is, so injection of fuel from the second injection ports 4 is suspended. At this time, as shown in FIG. 8B, the injection rate Q again becomes Q₁, and the after injection is started.

(4) Further, at the time t₁₀, when the maximum voltage applied to the piezo type actuator 19 is turned off, as shown in FIG. 8C, the control valve 16 moves from the full lift position L₁ to the top side of FIG. 4 and again returns to the closing position L₀ and is maintained as it is. This being so, the fuel in the control valve chamber 17 can no longer flow out to the return passage, and the control valve chamber 17 and first control chamber 8 rise in pressure. As a result, at the time t₁₁, the first needle valve 2 is biased to the closing side (bottom side of FIG. 4). As shown in FIG. 8D, at the time t₁₂, the first needle valve 2 becomes zero in lift the same as the amount of lift of the second needle valve 5 and the fuel injection completely ends.

(5) In this way, one cycle of the operation of the fuel injection system according to the present invention 100 ends. After this, this cycle is repeated.

Here, the actual injection pressure P of FIG. 8A will be explained. The “actual injection pressure” means the fuel pressure in the vicinity of the injection ports in the present specification. The actual injection pressure shown by the solid line in FIG. 8A shows the fuel pressure in the first injection port vicinity 1a (see FIG. 7), while the actual injection pressure shown by the one-dot chain line shows the fuel pressure in the second injection port vicinity 5a (see FIG. 7). Both of these are calculated values. At the time t₂, fuel starts to be injected from the first injection ports 1. When the initial injection starts, the actual injection pressure of the first injection ports rises. When reaching a pressure substantially the same as the common rail pressure (for example, 180 MPa) or a pressure P₂ somewhat lower than that, it is maintained as it is. The phenomenon of the actual injection pressure of the first injection ports becoming a pressure somewhat lower than the common rail pressure occurs when an amount the same as the amount of fuel injected from the first injection port vicinity 1a through the first injection ports 1 to the cylinder is not replenished from the upstream side of feed of fuel of the common rail in real time to the first injection port vicinity 1a.

Further, at the time t₅, fuel starts to be injected from the second injection ports 4. When the main injection is started, fuel positioned in the first injection port vicinity 1a passes through the first injection ports 1 and is injected in the cylinder. Simultaneously, it passes through the second injection ports 4 and is injected into the cylinder. Due to this, due to the total injection port area of the first injection port group, the total injection port area of the second injection port group, the amount of replenishment of fuel from the upstream side of feed of fuel of the common rail to the first injection port vicinity 1a, the shape of the fuel passage from the upstream side of feed of fuel of the common rail to the first injection port vicinity 1a, and other various factors, in the present embodiment, the actual injection pressure P of the first injection ports is a pressure P₁ lower than the pressure P₂ (for example, 150 MPa). This is because an amount the same as the amount of fuel injected from the first injection port vicinity 1a through the first injection ports 1 and second injection ports 4 to the inside of the cylinder is not replenished from the upstream side of feed of fuel of the common rail in real time to the first injection port vicinity 1a. In this embodiment, for the above-mentioned reason, the total injection port area of the first injection port group is made not more than the total injection port area of the second injection port group. This is one factor for the actual injection pressure P of the first injection port to be a pressure P₁ lower than the pressure P₂. Depending on the above parameters, P₁ can be made the same extent of pressure as P₂.

Further, at the time t₈, the second injection ports 4 start to be closed. When the main injection starts to end, the fuel injected from the first injection port vicinity 1a through the second injection ports 4 into the cylinder is reduced, so fuel is easily replenished with the upstream side of feed of fuel from the common rail. In this embodiment, the actual injection pressure P of the first injection ports again starts to rise. At the time t₉, after injection starts. When reaching a pressure P₂ substantially the same as the common rail pressure (for example; 180 MPa) or somewhat lower, this is maintained as it is. At the time t₁₁, the second injection ports 4 start to be closed. When the after injection starts to end, the actual injection pressure P of the first injection ports falls and injection ends at the time t₁₂.

Further, the actual injection pressure P of the second injection ports takes the form as shown by the one-dot chain line in FIG. 8A. At the time of full lift of the second needle valve 5 where the second injection ports 4 become fully open, the pressure reaches a pressure P₃ slightly lower than P₁.

As explained above, in the first embodiment, it is learned that the actual injection pressure during the after injection period becomes higher than the actual injection pressure during the main injection period.

### Second Embodiment

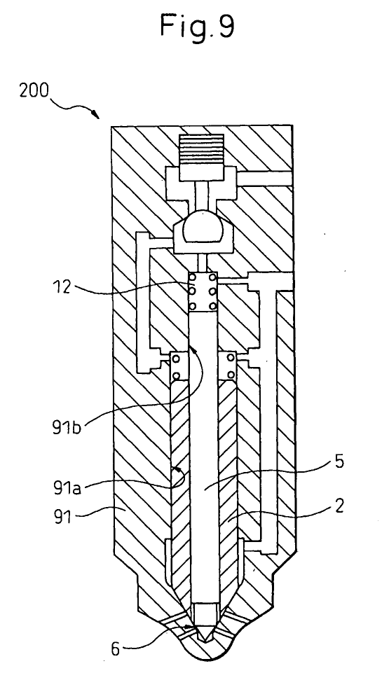

Next, a second embodiment of the fuel injection system according to the present invention will be explained. FIG. 9 is a sectional view of the second embodiment of the fuel injection system according to the present invention and is similar to FIG. 4 according to the first embodiment. The second embodiment basically differs from the first embodiment in that the lift lock piston is eliminated. The method of operation is the same as the first embodiment. As shown in FIG. 9, the cylinder part 91a of the valve body 91 is connected with the smaller inside diameter cylinder part 91b at the top side of the valve body. The second needle valve 5 is arranged to be able to freely slide inside the cylinder part 91b guided by the first needle valve 2.

The second embodiment, compared with the first embodiment, omits the lift lock piston, so is simplified in structure. The second control chamber 12 is small in inside diameter, so the fuel pressure of the second control chamber 12 causes the load acting on the second needle valve 5 to become smaller and the wear of the second seat part 6 to become smaller.

### Third Embodiment

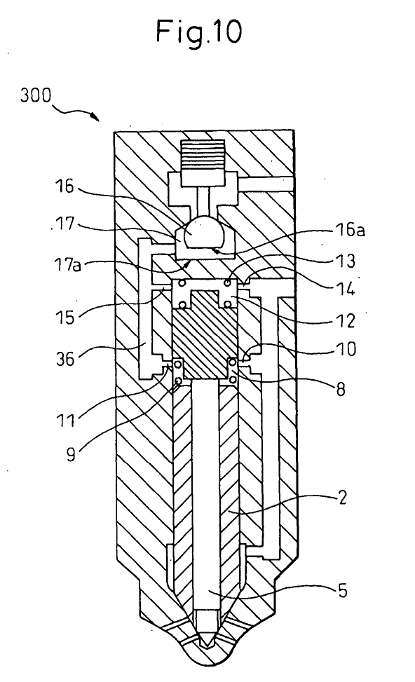

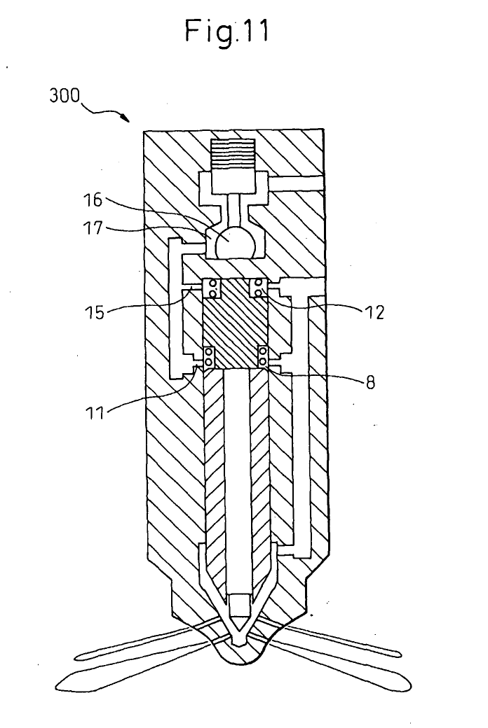

Below, a third embodiment of the fuel injection system according to the present invention will be explained. FIG. 10 is a sectional view of the third embodiment of the fuel injection system according to the present invention and is similar to FIG. 4 according to the first embodiment. In the same way as in FIG. 4, this shows a noninjection state where the lift of the pressure control valve 16 is made zero and fuel is not injected. Note that in the first embodiment to the third embodiment, compared with the later explained fourth embodiment or fifth embodiment, at the time of start of the initial injection, the first injection ports open, then the second injection ports open, while at the time of start of after injection, the second injection ports close, then the first injection ports close. The third embodiment differs in basic structure from the first embodiment in that the control valve is a two-position valve, the position of the second outlet orifice is a separate position, and in the relative relationship among six parameters, that is, the first inlet orifice passage sectional area, second inlet orifice passage sectional area, the first outlet orifice passage sectional area, second outlet orifice passage sectional area, mounting load of the first spring and mounting load of the second spring.

The second outlet orifice 15 of FIG. 4, in the third embodiment, may be arranged at any position at a location not closed by the bottom 16a of the control valve. That is, as shown in FIG. 10, the second outlet orifice 15 communicates with a passage 36 communicating the first control chamber 8 to the control valve chamber 17, so indirectly the second control chamber 12 is communicated with the control valve chamber 17. In the third embodiment, there is no intermediate lift position of the control valve, so the second outlet orifice 15 has to be changed in disposition.

The relative relationship among the six parameters is as follows.

(1) In the third embodiment, the passage sectional area of the first outlet orifice 11 is made the same as or larger than the passage sectional area of the second outlet orifice 15. This is so that, at the time of start of fuel injection, the fuel pressure in the first control chamber 8 is reduced faster than the fuel pressure in the second control chamber 12 and the first needle valve 2 is opened earlier than the second needle valve 5 to form the initial injection. Of course, even if the passage sectional area of the first outlet orifice 11 is the same extent as the passage sectional area of the second outlet orifice 15, the mounting load of the second spring 13 can be made larger than the mounting load of the first spring 9 etc. to make the first needle valve 2 open first.

(2) In the third embodiment, the passage sectional area of the first inlet orifice 10 is made smaller than the passage sectional area of the second inlet orifice 14. This is so as to, after the start of injection, raise the fuel pressure in the second control chamber 12 faster than the fuel pressure in the first control chamber 8 and close the second needle valve 5 before the first needle valve 2 to form the after injection. Of course, even if the passage sectional area of the first inlet orifice 10 is the same extent as the passage sectional area of the second inlet orifice 14, if baking the mounting load of the second spring 13 larger than the mounting load of the first spring 9 etc., it is possible to first make the second needle valve 5 close.

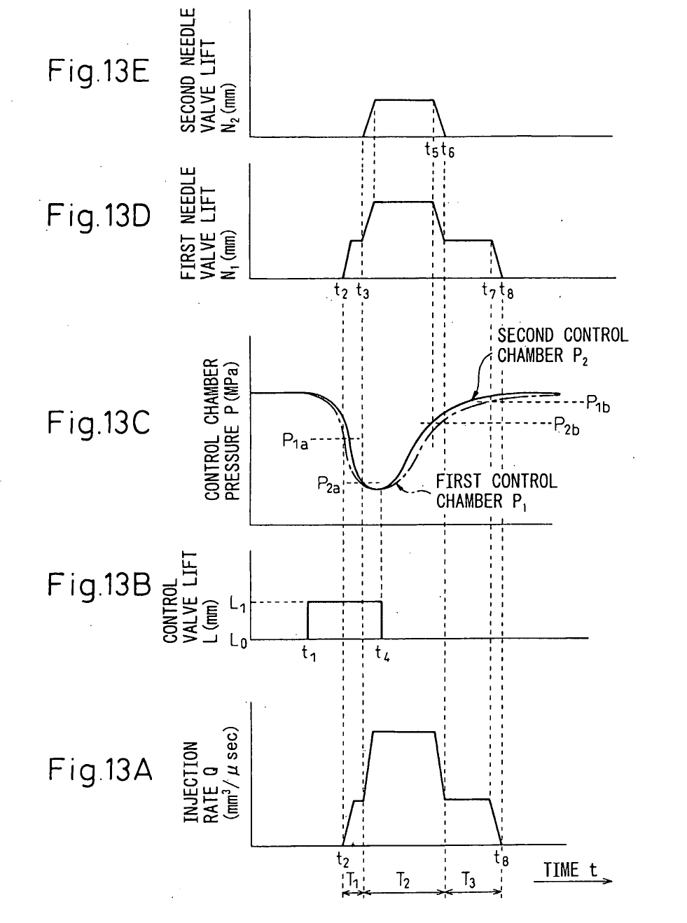

(3) In the third embodiment, the passage sectional area of the second outlet orifice 15 is made larger than the passage sectional area of the first inlet orifice 10. This is to make the rate of drop of the fuel pressure in the second control chamber 12 larger than the rate of rise of the fuel pressure in the first control chamber 8 (see FIG. 13C) and make the after injection period T₃ larger than the initial injection period T₁.

Next, FIG. 11 shows the time of main injection where fuel is injected from both the first injection ports and second injection ports and is a view similar to FIG. 5. However, in FIG. 5 according to the first embodiment, the pressure control valve 16 is arranged at the intermediate lift position, while in FIG. 11 according to the third embodiment, the pressure control valve 16 is arranged at the full lift position. In the third embodiment, the control valve is a two-position valve and the position of the second outlet orifice is a separate position.

Due to this, the fuel in the first control chamber 8 also can pass through the first outlet orifice 11 and control valve chamber 17 and flow out to the return passage, so the first control chamber 8 falls in pressure. As a result, the first needle valve 2 is lifted, and the first injection ports 1 inject fuel. Further, the fuel in the second control chamber 12 passes through the second outlet orifice 15 and control valve chamber 17 and flows out to the return passage, so the second control chamber 12 falls in pressure. As a result, the second needle valve 5 is lifted, and the second injection ports 4 inject fuel.

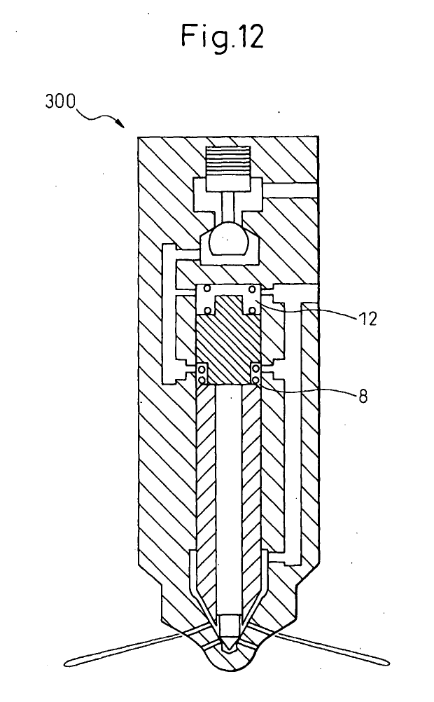

FIG. 12 is a view showing after injection where fuel is not injected from the second injection ports, but fuel is injected from the first injection ports and is similar to FIG. 6. However, in FIG. 6 according to the first embodiment, the pressure control valve 16 is arranged at the full lift position, while in FIG. 12 according to the third embodiment, the pressure control valve 16 is arranged at the zero lift position (closing position). FIG. 12 shows the nonsteady state in the time of transition from main injection to noninjection. The pressure in the second control chamber 12 is substantially the common rail pressure, but the pressure in the first control chamber 8 is still not a pressure close to the common rail pressure, so the first needle valve 2 opens the first injection ports 1 and the first injection ports 1 inject fuel.

Here, the operation of the fuel injection system 300 according to the third embodiment will be explained with reference to FIGS. 13A to 13E. Note that FIG. 13A shows the amount of injection per, time t in the system 300, that is, the injection rate, FIG. 138 shows the lift of the control valve with respect to time in the system, FIG. 13C shows the pressure of the control pressure P with respect to time in the system, that is, the pressure P₁ in the first control chamber 8 (shown by one-dot chain line) and the pressure P₂ in the second control chamber 12 (shown by solid line), FIG. 13D shows the lift of the first needle valve with respect to time in the system, and FIG. 13E shows the lift of the second needle valve with respect to time in the system. In FIGS. 13A to 13E, the time axes are exactly the same.

(1) At the time t₁, when the maximum voltage is applied to the piezo type actuator 19, as shown in FIG. 13B, the control valve 16 coupled with the piezo type actuator moves from the closing position L₀ to the bottom side of FIG. 10, abuts against the bottom 17a of the control valve chamber 17, and is maintained in that state at that abutting position. This abutting position becomes the full lift position L₁ of the control valve 16. Due to this, the fuel in the first control chamber 8 and the second control chamber 12 can pass through the first outlet orifice 11 and second outlet orifice 15, communication passage 36, and control valve chamber 17 and flow out to the return passage, so the first control chamber 8 and the second control chamber 12 fall in pressure. As a result, as shown in FIG. 13D, at the time t₂, the first control chamber pressure P₁ becomes P₁ₐ, the ascending force F₁ acting on the first needle valve 2 (see FIG. 7) overcomes the descending force f₁ due to the first control chamber pressure P₁ (see FIG. 7), the first needle valve 2 starts to be lifted to the top side of FIG. 10, the seat part 3 is opened, fuel starts to be injected from the first injection ports 1, and the initial injection is started. The first needle valve 2 is intermediately lifted and maintained in that state. At the time t₃, the second control chamber pressure P₂ becomes P₂ₐ, the ascending force F₂ acting on the first needle valve 2 (see FIG. 7) overcomes the descending force f₂ due to the second control chamber pressure P₂ (see FIG. 7), the second needle valve 5 also starts being lifted to the top side of FIG. 10, the seat part 6 opens, fuel starts to be injected from the second injection ports 4 as well, main injection is started, and the second needle valve 5 is fully lifted and is maintained in that state.

(2) At the time t₄, when the maximum voltage applied to the piezo type actuator 19 is turned off, as shown in FIG. 13B, the control valve 16 moves from the full lift position L₁ to the top side of FIG. 10, returns again to the closing position L₀, and is maintained as is. This being so, the fuel in the control valve chamber 17 can no longer flow out to the return passage, and the control valve chamber 17, first control chamber 8, and the second control chamber 12 rises in pressure. As a result, at the time t₅, the second control chamber pressure P₂ becomes P_{2b}, the descending force f₂ acting on the first needle valve 2 due to the second control chamber pressure P₂ (see FIG. 7) overcomes the ascending force F₂ (see FIG. 7) and the second needle valve 5 is biased to the closing side (bottom side of FIG. 11). As shown in FIG. 13E, at the time t₆, the second needle valve 5 becomes zero in lift. Further, at the time t₇, the first control chamber pressure P₁ becomes P_{1b}, the descending force f₁ due to the first control chamber pressure P₁ acting on the first needle valve 2 (see FIG. 7) overcomes the ascending force F₁ (see FIG. 7), and the first needle valve 2 is biased to the closing side (bottom side of FIG. 12). As shown in FIG. 13D, at the time t₈, the first needle valve 2 becomes the same in the amount of lift as the second needle valve 5, that is, zero, and the fuel injection completely ends.

### Fourth Embodiment

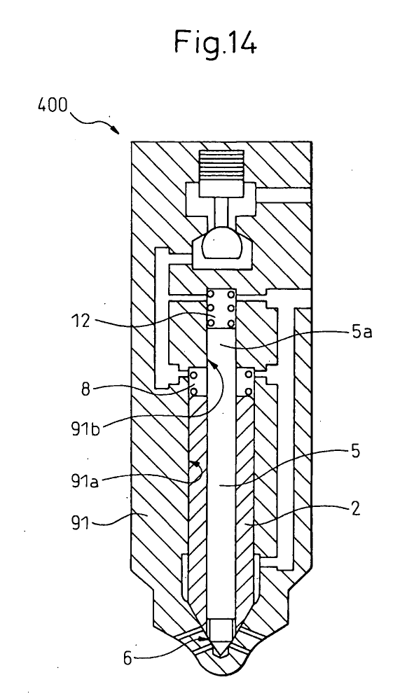

Next, a fourth embodiment of the fuel injection system according to the present invention will be explained. FIG. 14 is a sectional view of the fourth embodiment of the fuel injection system according to the present invention and is similar to FIG. 10 according to the third embodiment. The fourth embodiment basically differs from the third embodiment in that the lift lock piston is omitted. The method of operation is the same as in the third embodiment. As shown in FIG. 14, the cylinder part 91a of the valve body 91 is connected at the top side to the smaller inside diameter cylinder part 91b. The second needle valve 5 is arranged slidably inside the cylinder part 91b while being guided by the first needle valve 2.

The fourth embodiment, compared with the third embodiment, omits the lift lock piston, so is simplified in structure. Further, the second control chamber 12 is small in inside diameter, so the fuel pressure of the second control chamber 12 reduces the load applied to the second needle valve 5 and the wear of the second seat part 6 becomes smaller.

### Fifth Embodiment

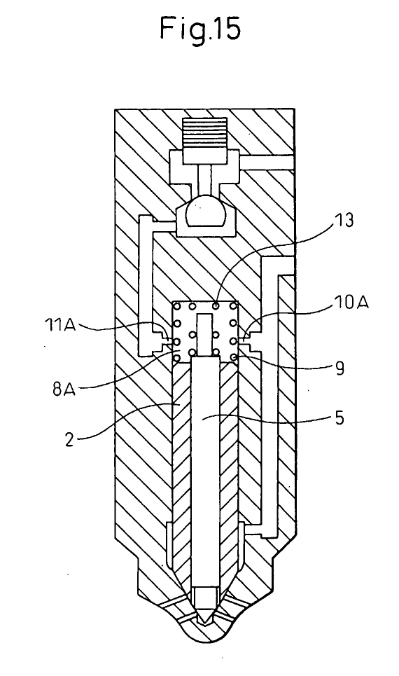

Next, a fifth embodiment of the fuel injection system according to the present invention will be explained. FIG. 15 is a sectional view showing the fifth embodiment of the fuel injection system according to the present invention and is similar to FIG. 14 according to the fourth embodiment. The fifth embodiment basically differs from the fourth embodiment in that the first control chamber and the second control chamber are made a single common control chamber 8A, along with this, the first inlet orifice and the second inlet orifice are made a single common inlet orifice 10A, and the first outlet orifice and second outlet orifice are made a single common inlet orifice 11A. The method of operation is the same as in the fourth embodiment.

In the fifth embodiment, the relative relationship between the inlet orifice passage sectional area and the outlet orifice passage sectional area and the relative relationship between the mounting load of the first spring and the mounting load of the second spring become important.

(1) By making the mounting load of the second spring 13 larger than the mounting load of the first spring 9, it is possible to make the first needle valve 2 open at the time of start of injection and possible to make the second needle valve 5 close first at the time of start of after injection.

(2) The passage sectional area of the outlet orifice 11A is made larger than the passage sectional area of the inlet orifice 10A. This is to make the speed of decline of the fuel pressure in the control chamber 8A faster than the speed of ascent of the fuel pressure in the control chamber 8A (see FIG. 13C) and make the after injection period T₃ larger than the initial injection period T₁.

The fifth embodiment is simplified in structure compared with the fourth embodiment, so the fuel injection system can be made more compact and the reliability can be improved.

### Sixth Embodiment

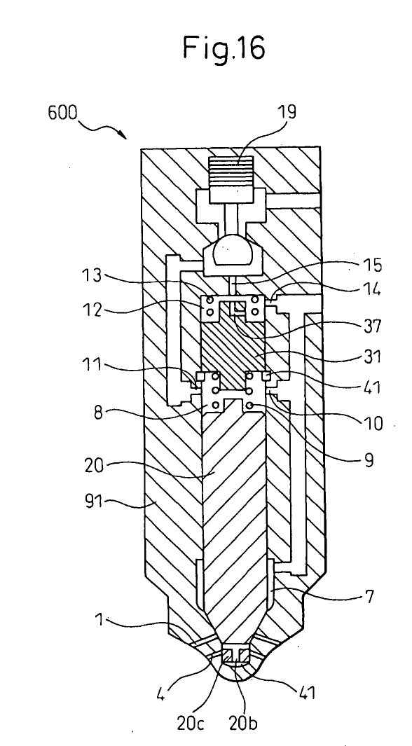

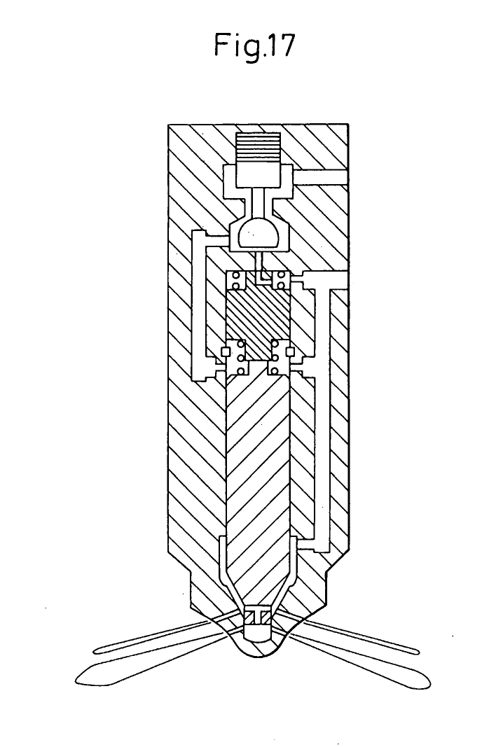

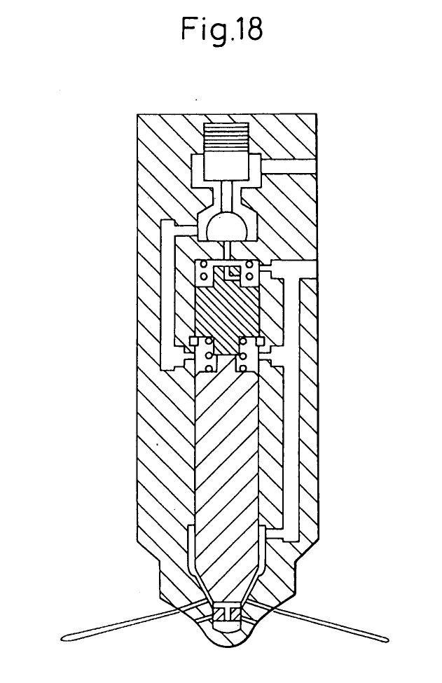

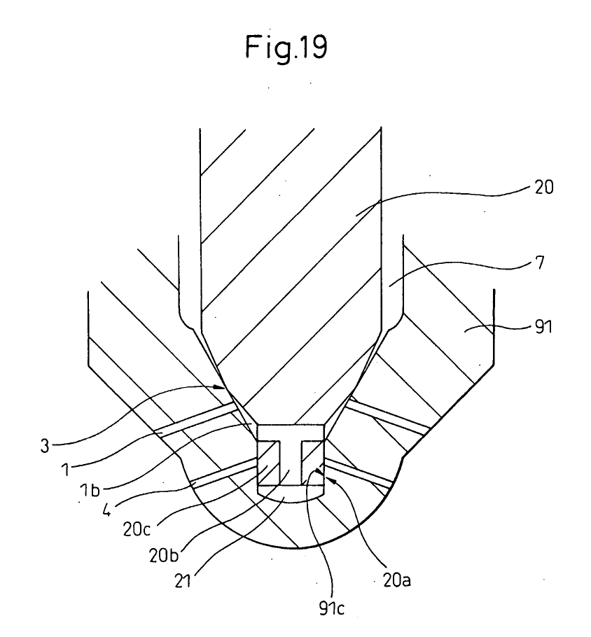

Next, a sixth embodiment of the fuel injection system according to the present invention will be explained. FIG. 16 is a sectional view of the sixth embodiment of the fuel injection system according to the present invention and is similar to FIG. 4 according to the first embodiment. It shows the time of noninjection when no fuel is injected. Further, FIG. 17 is a sectional view at the time of main injection in the sixth embodiment, while FIG. 18 is a sectional view at the time of after injection of the sixth embodiment. FIG. 19 is an enlarged view of FIG. 17 and shows details of the route of the fuel from the fuel reservoir chamber 7 to the first injection ports 1 and second injection ports 4.

The sixth embodiment basically differs from the first embodiment in that the first needle valve and the second needle valve are made an integral pintle type needle valve, in relation to this, the second injection port is set at a position enabling sealing by the tip sliding part of the pintle type needle valve, and a stopping member 41 (for example, a snap ring) limiting the movement of the lift lock piston in the downward direction in FIG. 16 is set. The method of operation is substantially the same as in the first embodiment.

The injector 600 according to the sixth embodiment, as shown in FIG. 16 and FIG. 19, provides the tip of the needle valve 20 with a projection 20c, provides the tip of the valve body 91 with a cylindrical sliding part 91c in which the projection 20c may slide, and provides the sliding part 91c with second injection ports 4 opening in accordance with the rise (lift) of the needle valve 20. Further, the projection 20c is formed with a communication passage 20b communicating the fuel reservoir chamber 7 at the upstream side from the first seat part 3 of the needle valve 20 and a suck chamber 21 at the tip side of the sliding part 91c at the time of opening of the needle valve 20.

Further, as shown in FIG. 19, when the lift of the needle valve 20 is low, the fuel travels from the fuel reservoir chamber 7 through the first seat part 3 and is injected from only the upstream side first injection ports 1. Further, if the lift of the needle valve 20 becomes higher, the fuel is not only supplied from the first injection ports 1, but also travels from the fuel reservoir chamber 7 and from the first seat part 3 through the fuel reservoir chamber 1b near the first injection ports, passes through the communication port 20b provided at the tip 20c of the pintle type needle valve, flows into the suck chamber 21, and is injected from the second injection ports 4 at the tip side opened from the projection 20c (bottom side of FIG. 19) as well.

Further, the stopping member 41 limits movement of the lift lock piston 31 in the downward direction in FIG. 16 so as not to impair the opening and closing of the first injection ports 1 by the needle valve 20. That is, by just the fuel pressure in the first control chamber 8 and the first spring 9, the opening and closing of the first injection ports 1 by the needle valve 20 can be controlled.

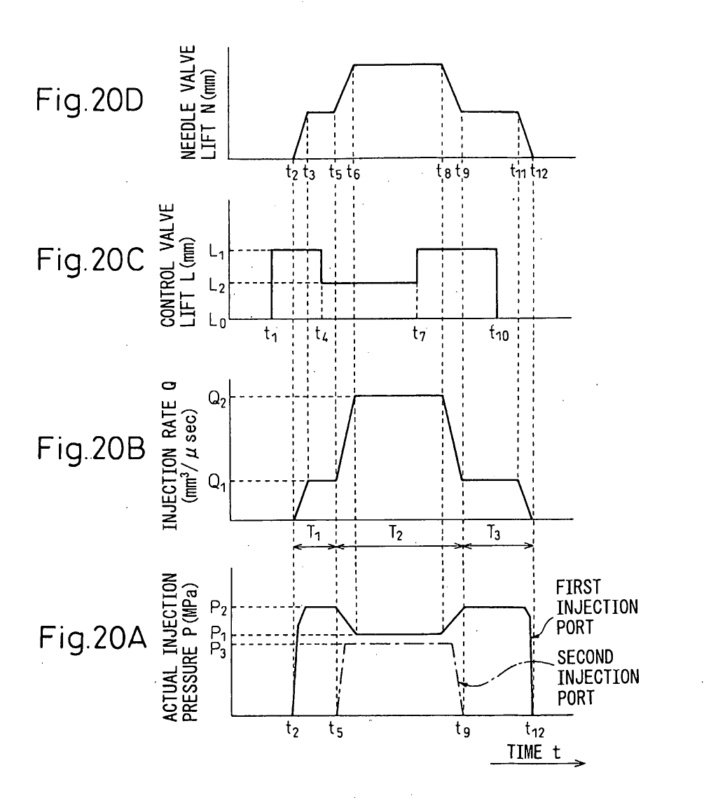

Here, the operation of the fuel injection system 600 according to the sixth embodiment will be explained with reference to FIGS. 20A to 20D focusing only on locations different from FIGS. 8A to 8E according to the first embodiment. FIGS. 20A to 20C show items the same as FIGS. 8A to 8C. FIG. 20D shows the lift of the needle valve with respect to the time t of the system 600. In FIGS. 20A to 20D, the time axes are exactly the same.

(1) The operation from the time t₁ to t₃ is the same as in the first embodiment. The operation of the first needle valve 2 of the first embodiment is the same as the operation of the needle valve 20 of the sixth embodiment. The lift of the needle valve 20 from the time t₂ to t₃ is called the “first lift”.

(2) At the time t₄, if the maximum voltage applied to the piezo type actuator 19 is reduced to the intermediate voltage, as shown in FIG. 8C, the control valve 16 moves from the full lift position L₁ to the top side of FIG. 16 and is maintained at the intermediate lift position L₂ not abutting against the bottom 17a or the seat surface 17b of the control valve chamber 17. As a result, further, the fuel in the second control chamber 12 can flow out through the second outlet orifice 15 and control valve chamber 17 to the return passage, so the second control chamber 12 falls in pressure. As shown in FIG. 8D, at the time t₅, the needle valve 20 starts the second lift, fuel starts to be injected from the second injection ports 4 which had been sealed by the tip projecting sliding part 20a of the needle valve 20, and the main injection is started. Further, at the time t₆, the second needle valve 5 is fully lifted and is maintained in that state. At this time, as shown in FIG. 20B, the amount of injection per time from the first injection ports 1 and second injection ports 4, that is, the injection rate, becomes the maximum value Q₂.

(3) Further, at the time t₇, when the intermediate voltage applied to the piezo type actuator 19 is further increased to the maximum voltage, as shown in FIG. 20C, the control valve 16 moves from the intermediate lift position L₂ to the bottom side of FIG. 16 and is maintained at the full lift position L₁. As a result, the control valve 16 closes the second outlet orifice 15, so the pressure in the second control chamber 12 rises due to the supply of fuel from the common rail and finally becomes the common rail pressure, therefore at the time t₈, the needle valve 20 starts to move to the bottom side of FIG. 16 via the lift lock piston 31. At the time t₉, the second injection ports 4 are closed and the lift lock piston 31 abuts against the stopping member 41 so is maintained in that state, therefore the supply of fuel from the second injection ports 4 is suspended. At this time, as shown in FIG. 8B, the injection rate Q again becomes Q₁ and after injection is started. The operation after this is the same as the first embodiment.

### Seventh Embodiment

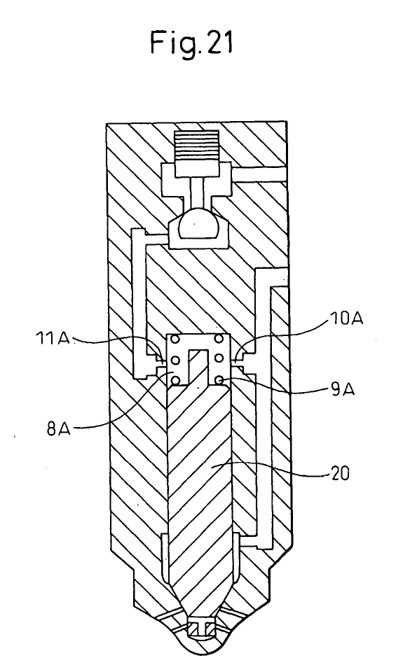

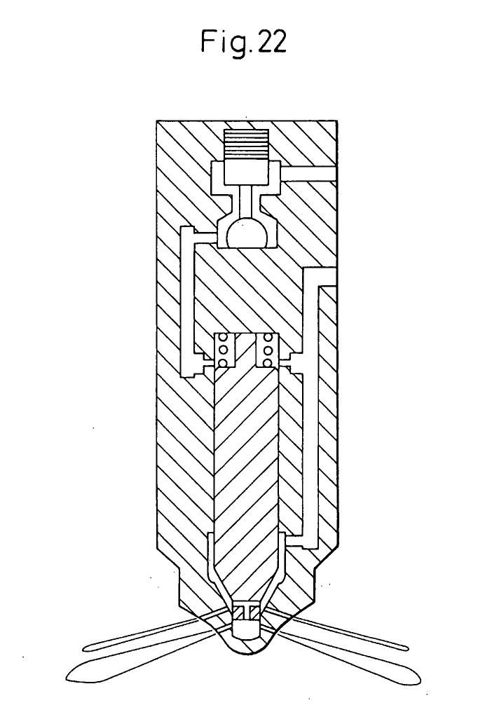

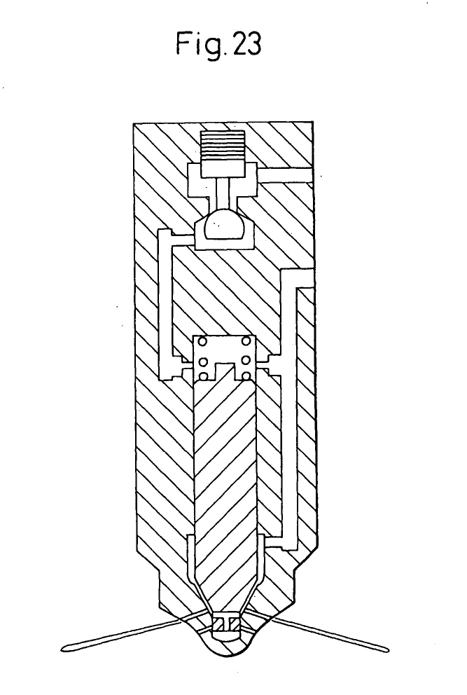

Next, a seventh embodiment of the fuel injection system according to the present invention will be explained. FIG. 21 is a sectional view of the seventh embodiment of the fuel injection system according to the present invention and is similar to FIG. 15 of the fifth embodiment. It shows the time of noninjection when no fuel is injected. FIG. 22 shows the time of main injection of the seventh embodiment, while FIG. 23 shows the time of after injection of the seventh embodiment. The seventh embodiment basically differs from the fifth embodiment in that the first needle valve and the second needle valve are made an integral pintle type needle valve, in relation to this, the second injection ports are set at a position enabling sealing by the tip sliding part of the pintle type needle valve (the above the same as the sixth embodiment), and further the first spring and the second spring become a single common spring 9A. The method of operation is substantially the same as in the fifth embodiment.

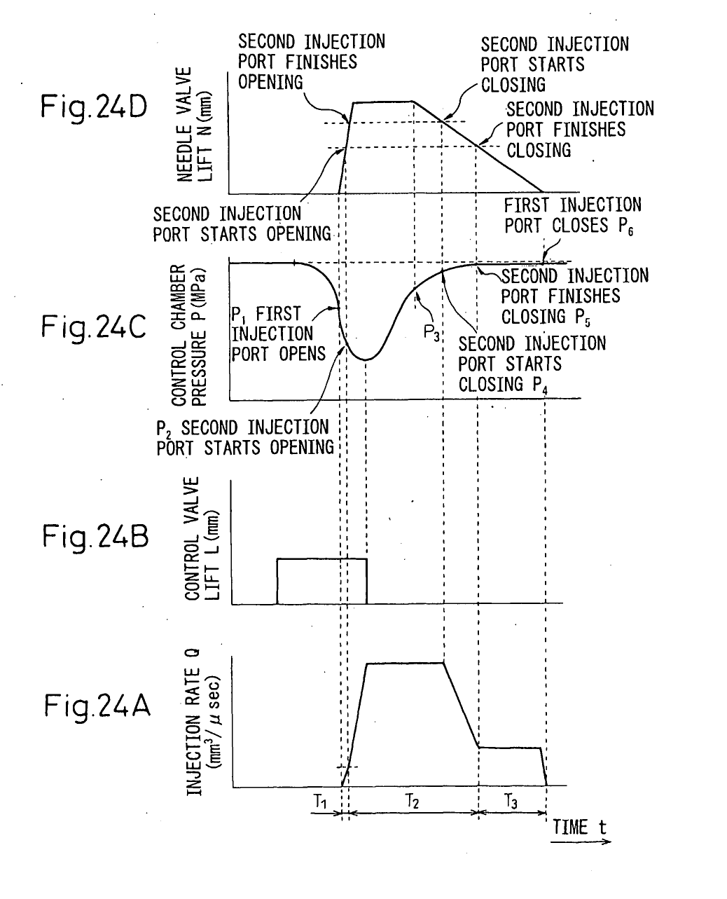

In the seventh embodiment, the relative relationship between the inlet orifice passage sectional area and outlet orifice passage sectional area becomes important. The passage sectional area of the outlet orifice 11A is made larger than the passage sectional area of the inlet orifice 10A. This is so as to make the speed of drop of the fuel pressure in the control chamber 8A larger than the speed of drop of the fuel pressure in the control chamber 8A (see FIG. 24C) and make the after injection period T₃ longer than the initial injection period T₁.

The seventh embodiment is simplified in structure compared with the fifth embodiment, so the fuel injection system can be made more compact and improved in reliability. Further, since the first needle valve and the second needle valve are changed to an integral pintle type special needle valve, at the time of start of the initial injection, the first injection ports open, then the second injection ports open, while at the time of start of after injection, the second injection ports close, then the first injection ports close. (In the fifth embodiment, the first needle valve and the second needle valve are separate, so this is not reliably guaranteed.)

### Eighth Embodiment

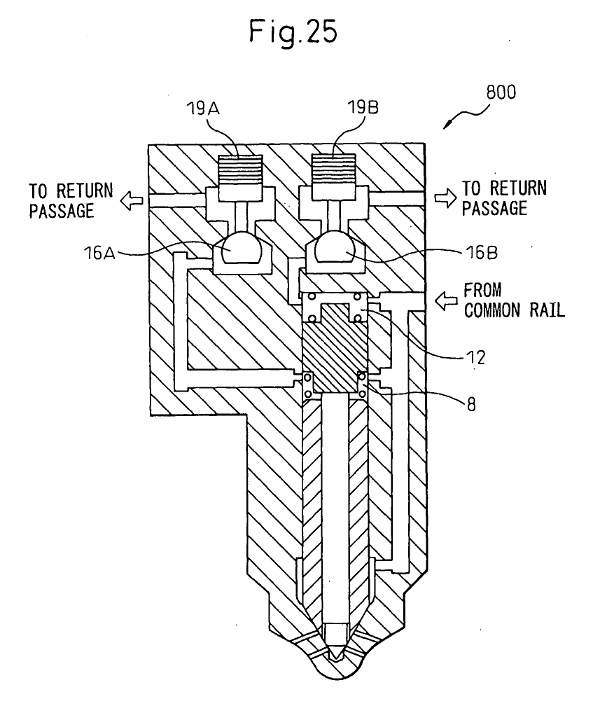

Next, an eighth embodiment of the fuel injection system according to the present invention will be explained. FIG. 25 is a sectional view of the eighth embodiment of the fuel injection system according to the present invention and is similar to FIG. 4 according to the first embodiment. The eighth embodiment basically differs from the first embodiment in dividing the functions of the single three-position control valve to the functions of two two-position control valves. The method of operation is the same as the operation of the first embodiment except for FIG. 8C. In the eighth embodiment, the first control chamber 8 is controlled in fuel pressure by the first control valve 16A, while the second control chamber 12 is controlled in fuel pressure by the second control valve 16B. In FIG. 8C, at the time t₁, voltage is applied to the first piezo type actuator 19A for full lift of the first control valve 16A. At the time t₁₀, the voltage is turned off for zero lift. Further, at the time t₄, voltage is applied to the second piezo type actuator 19B for full lift of the second control valve 16B. At the time t₇, the voltage is turned off for zero lift. Due to this, the same functions and operations as shown in FIGS. 8A, 8B, BD, and 8E are obtained.

The eighth embodiment employs two two-position control valves to enable free control of the after injection period. Note that a two-position control valve is a device securing greater operational stability and reliability than a three-position control valve, so operational stability and reliability are also secured in the fuel injection system 800 according to the eighth embodiment. However, since two control valves are employed, the size becomes larger.

While the invention has been described with reference to specific embodiments chosen for purpose of illustration, it should be apparent that numerous modifications could be made thereto by those skilled in the art without departing from the basic concept and scope of the invention.

1. A fuel injection system storing pressure of the high pressure fuel fed from a fuel feed pump in a common rail and injecting the high pressure fuel stored in said common rail into a combustion chamber of an internal combustion engine,
the fuel injection system characterized by being provided with a valve body, a first injection port group and second injection port group provided at said valve body and injecting fuel, and at least one operating valve operating said first injection port group and said second injection port group;
performing after injection consecutively after main injection in a high load region, injecting fuel from said first injection port group and said second injection port group at the time of main injection, and injecting fuel from said first injection port group at the time of after injection;
controlling an actual injection pressure near the first injection port during the after injection period to be higher than an actual injection pressure near the first injection port during the main injection period; and
controlling the operating valve to open the first injection port group to start injection, then controlling the operating valve to open the second injection port group as well to perform main injection simultaneously or in a short time, then controlling the operating valve to close the second injection port group then perform after injection, and, after the elapse of a time longer than the simultaneously or short time from the start of injection, controlling the operating valve to also close the first injection port group to end injection.

2. A fuel injection system as set forth in claim 1, characterized by enabling the injection period of said after injection to be variably controlled.

3. A fuel injection system as set forth in claim 1, wherein the speed by which said operating valve moves from a full lift position to a closing position when closing said first injection port group by said operating valve is slower than the speed by which said operating valve moves from the closing position to the full lift position when opening said first injection port group by said operating valve.

4. A fuel injection system as set forth in claim 1, wherein a total injection port area of said first injection port group is not more than a total injection port area of the second injection port group and the injection port sizes of said first injection ports are not more than the injection port sizes of said second injection ports.

5. A fuel injection system as set forth in claim 1, wherein said first injection port group is arranged at an upstream side constituting a fuel feed side, while said second injection port group is arranged at a downstream side at an opposite side to the fuel feed side.

6. A fuel injection system as set forth in claim 1, wherein fuel is injected consecutively in the order of initial injection, main injection, and after injection, fuel is injected from said first injection port group at the time of the initial injection, fuel is injected from said first injection port group and said second injection port group at the time of main injection, and fuel is injected from said first injection port group at the time of after injection.

7. A fuel injection system as set forth in claim 1, wherein fuel is injected from only said first injection port group in a partial load region and fuel is injected from both said first injection port group and said second injection port group in a high load region.

8. A fuel injection system as set forth in claim 1, wherein
said valve body is formed in a closed-bottom cylindrical shape, is fed with fuel in the cylinder, and has said first injection port group and said second injection port group at its bottom side; and
said operating valve is housed in said valve body to be able to freely move back and forth and is provided with
at least one control chamber communicated with said common rail and controlling the operation of said operating valve,
at least one control valve chamber communicated with said control chamber, and
at least one control valve for controlling the fuel pressure in said control valve chamber.

9. A fuel injection system as set forth in claim 8, wherein
a passage communicating said common rail and said control chamber is provided with an inlet orifice,
a passage communicating said control chamber and said control valve chamber is provided with an outlet orifice, and
a passage sectional area of said inlet orifice is smaller than a passage sectional area of said outlet orifice.

10. A fuel injection system as set forth in claim 8, wherein
said at least one operating valve is comprised a first operating valve operating said first injection port group and a second operating valve operating said second injection port group,
said first operating valve and said second operating valve are comprised of outside tube members and members inserted into said outside tube members,
said control chamber is comprised of a first control chamber for controlling the operation of said first operating valve and a second control chamber for controlling the operation of said second operating valve, and
said control valve chamber is communicated with said first control chamber and said second control chamber.

11. A fuel injection system as set forth in claim 10, wherein a lift lock piston is disposed between said first control chamber and said second control chamber.

12. A fuel injection system as set forth in claim 10, wherein
a passage communicating said common rail and said first control chamber is provided with a first inlet orifice,
a passage communicating said common rail and said second control chamber is provided with a second inlet orifice,
a passage communicating said first control chamber and said control valve chamber is provided with a first outlet orifice,
a passage communicating said second control chamber and said control valve chamber is provided with a second outlet orifice, and
a passage cross-sectional area of said second outlet orifice is larger than a passage sectional area of said first inlet orifice.

13. A fuel injection system as set forth in claim 8, wherein said control valve is a three-position control valve.
